(19) United States
(12) Patent Application Publication
(10) Pub. No.: US 2008/0152920 A1
(43) Pub. Date: Jun. 26, 2008

(54) Image bearing composite article and method of making same

(76) Inventor: Marvin Carlston, Lehi, UT (US)

Correspondence Address: THORPE NORTH & WESTERN, LLP., P.O. Box 1219, SANDY, UT, 84091-1219, US

(21) Appl. No.: 11/645,020

(22) Filed: Dec. 21, 2006

(51) Int. Cl. B32B 9/00; B05D 3/02

(52) U.S. Cl. 428/411.1; 427/393.5

(57) ABSTRACT

A composite article includes a plurality of plies of composite material arranged atop one another to form a stack that is bonded together with a resin material. An image layer is integrally formed with the stack and visible on at least one outer surface of the stack. The image layer bears an image applied to the image layer by a conventional printing process prior to curing of the resin material in the stack of layers. The image layer includes a saturating cellulose material that is saturable with the resin material prior to curing of the composite article to incorporate the image layer into the stack of plies by surrounding and infiltrating the saturating cellulose material of the image layer with the resin material.

### BACKGROUND

1. Field of the Invention

The present invention relates to composite structures, and more particularly to composite structures bearing markings, indicia, designs, logos or the like.

2. Description of the Related Art

The fabrication of composite structures or articles, and assemblies made from such elements, to obtain increased strength-to-weight characteristics and other improved properties is well known. Such elements typically are comprised of high strength fibers embedded in a polymer resin matrix. In a similar manner, assemblies of composite materials are made from layers of such elements embedded in a polymer resin. The typical process for forming a composite structure entails building a stack of layers or plies of composite material and embedding the entire stack in the polymer resin matrix. In this situation, each ply can be the same or different material and the fibers in each ply can be wrapped with different braiding patterns to satisfy pre-specified requirements of a particular structure.

The processes and the apparatus for the fabrication of such composite include pultrulsion and resin transfer molding, and the fiber materials, which have included aramid, kevlar, glass, carbon, graphite, ceramics and a variety of metals, are immersed in a polymer matrix material. Typically, the polymer matrix material is a thermoset resin such as polyester or epoxy resin, or it can be a thermoplastic resin such as nylon, polypropylene, polycarbonate, etc.

Many composite articles require labeling on exterior surfaces for environmental, aesthetic, identification or safety reasons. As a rule the exterior surfaces of composite articles do not lend themselves to printing of indicia which is visually distinct and easily recognizable. As an example, most composite articles have optically dark surfaces due to coloration of the resin and fiber mixtures. Thus, when imprinted with designs or indicia, the resultant image is difficult, if not nearly impossible, to see.

Some attempts to solve this problem have included incorporating an optically-light coloration additive, such as titanium dioxide, into the resin mixture that renders the surfaces of the article ready for application of visually distinct printed image following curing of the article. Unfortunately, such additives add considerable expense in both material and time to the composite fabrication process.

Another marking method has included sublimation printing of an image on a polyester weave or fabric which is then integrated into the composite stack by wetting the polyester weave with the polymer resin matrix. Unfortunately, with this method portions of the printed image are lost in the spaces between the fibers of the polyester weave so that the image on the finished marked composite article often has a blurry or fuzzy appearance.

### SUMMARY OF THE INVENTION

It has been recognized that it would be advantageous to develop a composite article that has an image layer printed by a conventional printing process. It has also been recognized that it would be advantageous to develop a composite article that has an image layer formed of a saturating cellulose material having a substantially continuous surface so as to maintain the resolution of an image printed on the image layer.

The present invention provides for a composite article including a plurality of plies of composite material arranged atop one another to form a stack that is bonded together with a resin material. An image layer can be integrally formed with the stack and visible on at least one outer surface of the stack. The image layer can bear an image applied to the image layer by a conventional printing process prior to curing of the resin material in the stack of layers.

In a more detailed aspect, the image layer of the present invention can include a saturating cellulose material that can be saturable with the resin material prior to curing of the composite article to incorporate the image layer into the stack of plies by surrounding and infiltrating the saturating cellulose material of the image layer with the resin material.

The present invention also provides for a method for fabricating an article of composite material including stacking a plurality of plies made from composite materials on top of one another to form a composite stack. The composite stack can be wetted by surrounding and infiltrating each of the plurality of plies with an uncured resin material. An image can be printed on an image layer with a conventional printer. The image layer can be placed on the stack of plies so that the printed image is visible on at least a portion of one outer surface of the stack of plies. The image layer can be wetted with the uncured resin material to incorporate the image layer into the stack of plies by surrounding and infiltrating a saturating cellulose material of the image layer with the uncured resin material. The resin material can be cured to integrate the image layer into the composite article.

Additional features and advantages of the invention will be apparent from the detailed description which follows, taken in conjunction with the accompanying drawings, which together illustrate, by way of example, features of the invention.

### BRIEF DESCRIPTION OF THE DRAWINGS

FIG. 1 is perspective view of an article of composite material having an image layer in accordance with an embodiment of the present invention; and

FIG. 2 is a schematic cross section of an image layer of the article shown in FIG. 1; and

FIG. 3 is a schematic cross-section taken through the article shown in FIG. 1 along section lines 2-2

### DETAILED DESCRIPTION OF EXAMPLE EMBODIMENT(S)

Reference will now be made to the exemplary embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

The present invention provides generally for a composite article having an image bearing outer surface. The composite article can be formed from a plurality of composite plies including aramid, kevlar, glass, carbon, graphite, ceramics, and a variety of metal materials. The plurality of plies can be placed on top of one another to form a composite stack. The plurality of plies in the composite stack can be immersed in a polymer matrix material, or resin. An image layer can be disposed in the composite stack and can be visible on at least a portion of an outer surface of the stack. The image layer can have an image printed on one side. The image can be formed of ink and can be printed onto the image layer by a conventional printing process, such as ink jet printing, laser printing, ink plotting, and the like. The image layer can include a cellulose material that can be substantially continuous and free from perforations, discontinuities, holes, apertures, or the like, which may allow the ink to transfer from the image side to the non-image side of the image layer. The image layer can be disposed on the composite stack and can be immersed in the polymer matrix resin. The cellulose material of the image layer can absorb and become saturated with the resin material. The cellulose material can maintain its integrity after becoming saturated with the resin material. In this way the image layer can become an integrated layer in the composite stack after curing of the polymer matrix resin.

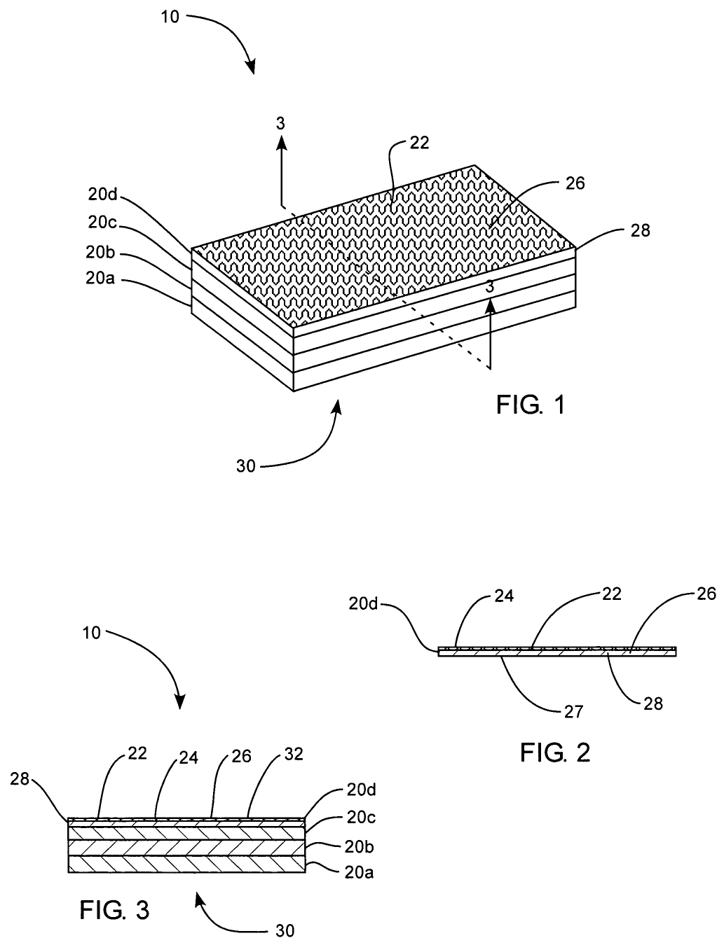

As illustrated in FIGS. 1-3, a composite article, indicated generally at 10, is shown in accordance with an embodiment of the invention, including a plurality of plies, or layers, indicated as 20a, 20b, 20c and 20d, and disposed adjacent to one another. The plies can be formed of any composite material, such as aramid, kevlar, glass, carbon, graphite, ceramics, and a variety of metal materials. Each of the plies can exhibit unique mechanical properties and add to the structural integrity of the composite article 10.

A polymer matrix material or resin (not shown) can immerse the plies and bond the layers together. Together the plurality of plies 20a, 20b, and 20c and the resin form composite a stack, indicated generally at 30.

The composite article 10 can also include an image layer 20d. The image layer 20d can be the upper ply in the composite stack 30 and can be visible to an observer in the finished, cured article. The image layer 20d can bear a graphic, such as a photograph, picture, logo, pattern, or the like. The image layer 20d can also bear symbolic information, such as alphanumeric characters, bar coding, color coding, or the like

It will be appreciated that various articles, including boat hulls and masts, the outer skins of aircraft and other vehicles, sporting equipment, furniture, shelving, etc., are desirably manufactured using composite structures. Each of these articles often require some form of labeling or decoration for aesthetics, identification, warning, or advertisement. For example, equipment or vehicles can be marked for identification or decorated with camouflage, while identifying indicia and manufacturing logos can be applied to articles which form the bulk of a retailer's inventory. Thus, in one aspect, the stack can be sized and shaped as an article of sporting equipment, such as a golf club shaft, a fishing rod, an arrow shaft, a hockey stick, a bat, a racquet, a ski pole, and a walking stick. In another aspect, the stack can be sized and shaped as a watercraft hull, aircraft fuselage, vehicle body panel, or the like. In any case, the image layer 20d of the present invention advantageously allows application of labeling and/or decoration to a composite article by a conventional printing process, such as ink jet printing, laser printing, ink plotting, hand writing, and the like.

The image layer 20d can be integrated into the composite stack 30 prior to curing the resin so that the image layer 20d is a constituent part of the cured composite article 10. In this way, the image layer 20d is distinguishable from an image layer or coating that is applied to the otherwise complete and cured article.

The image layer 20d can be visible on at least one outer surface of the composite stack 30, and can bear a graphic image or symbolic representations. The image 22 on the image layer can be applied to the image layer 20d by a conventional printing process, such as ink jet printing, laser printing, ink plotting, hand writing, and the like, prior to placing the image layer on the composite stack. It will be appreciated that one or more image layers 20d could be positioned on one or all outer facing sides of the composite stack 30.

The image layer 20d also includes a saturating cellulose material. By way of example, and without limitation to the concepts of the present invention, the saturating cellulose material can include a wood pulp material. Additionally, in one aspect, the image layer 20d can be a sheet 28 of saturating cellulose material. The sheet 28 can be flexible and can conform to the shape of the composite stack 30. The sheet 28 can be planar and can conform to a non-planar shape when pressed onto the composite stack 30. For example, in the case where the composite stack 30 forms an arrow shaft, the planar sheet 28 of cellulose material can be wrapped around the composite shaft to form a substantially cylindrical shape.

The cellulose material can absorb and become saturated by the resin material prior to curing of the composite article. For example, the composite stack 30, including the image layer 20d and polymer matrix resin, can be placed into a vacuum bag and a vacuum pressure can be applied such that the resin is drawn through the cellulose material. In this way, the image layer 20d can be incorporated into the stack of plies 30 by surrounding and infiltrating the saturating cellulose material of the image layer with the resin material.

In one example, the sheet 28 of cellulose material can be white in color. The coloring of the cellulose material can remain unaffected by the infusion of the resin material. Advantageously, the white coloring can mask the darker color of the composite materials used in the composite stack. In this way, the white coloring of the cellulose material can provide a suitable background against which the image can be viewed. In another aspect, the cellulose material can be whitewashed with a white pigment in order to ensure a light background upon which ink may be deposited. In yet another aspect, the cellulose material can be substantially translucent such that the image can appear on top of the dark color of the composite material.

As shown in FIG. 2, the image layer 20d can also include an ink layer 24 disposed substantially on an image side 26 of the cellulose material 28. In one aspect, the ink layer 24 can substantially cover the entire image 26 side of the image layer 20d. The ink layer 24 can form the image 22, and can be deposited onto the cellulose material by a conventional printing process. The ink layer 24 can be formed of any conventional type inks capable of withstanding the heat and pressure of the resin curing process. Thus, the ink layer can be formed by water based inks, oil based inks, and the like, as known in the art.

The saturating cellulose material can be substantially continuous and substantially free of perforations, discontinuities, holes, or apertures so that the ink layer 24 can be restricted to the image side 26 of the cellulose material, and bleed through of the ink to the non-image side 27 can be reduced. In this way, the image 22 can have a sharper resolution than has been achieved with other materials used as the image layers.

Referring to FIG. 3, the image 22 on the surface 32 of the article 10 can remain below or flush with the outer surface 32 of the composite stack 30. In this way, the ink layer 24 of the image 22 does not extend above the surface 32 of the layer 20d on which the image has been applied. This is because the ink layer 24 of the image 22 can be applied over substantially the entire image side 26 of the cellulose material 28 of the image layer 20d by the conventional printing process. The result is that only a smooth, unflawed, surface is felt when a user runs a hand or fingers over the image on the outer surface.

The present invention also provides for a method for fabricating an article of composite material including stacking a plurality of plies made from composite materials on top of one another to form a composite stack. The composite stack can be wetted by surrounding and infiltrating each of the plurality of plies with an uncured resin material. An image can be printed on an image layer with a conventional printer, such as an ink jet printer, a laser printer, a pen plotter, a hand writing instrument. The image layer can be placed on the stack of plies so that the printed image is visible on at least a portion of one outer surface of the stack of plies. The image layer can be wetted with the uncured resin material to incorporate the image layer into the stack of plies by surrounding and infiltrating a saturating cellulose material of the image layer with the uncured resin material. The resin material can be cured to integrate the image layer into the composite article.

The step of printing an image on an image layer can also include depositing an ink layer on an image bearing side of the saturable cellulose material. The saturable cellulose material can be substantially free of perforations or discontinuities such as holes or apertures in order to restrict transferance of ink through the saturable cellulose material to a non-image bearing side.

The step of wetting the image layer with the uncured resin can also include exposing the composite stack and image layer to a vacuum pressure to draw resin through the image layer to infiltrate and surround the cellulose material of the image layer.

The method can also include disposing a sealing material about the composite stack and the image layer prior to curing of the resin in the composite stack.

While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention. Accordingly, it is not intended that the invention be limited, except as by the claims set forth below.

What is claimed is:

1. A composite article, comprising:
a) a plurality of plies of composite material arranged atop one another to form a stack and bonded together with a resin material;
b) an image layer integrally formed with the stack and visible on at least one outer surface of the stack, and bearing an image applied to the image layer by a conventional printing process prior to curing of the resin material in the stack of layers.

2. A composite article in accordance with claim 1, wherein the image layer further comprises:
a) a saturating cellulose material saturable with the resin material prior to curing of the composite article to incorporate the image layer into the stack of plies by surrounding and infiltrating the saturating cellulose material of the image layer with the resin material; and
b) an ink layer disposed substantially on an image side of the cellulose material, the ink layer forming the image.

3. The composite article of claim 2, wherein the saturating cellulose material is substantially free of perforations such that the ink layer is restricted to the image side of the cellulose material.

4. The composite article of claim 1, wherein the conventional printing process is selected from the group consisting of ink jet printing, laser printing, pen plotting, hand writing, and combinations thereof.

5. The composite article of claim 1, wherein said image is selected from the group consisting of a logo, design pattern, alpha-numeric characters, a graphic, a photograph, a picture, and combinations thereof.

6. The composite article of claim 1, wherein said stack is sized and shaped as an article of sporting equipment.

7. The composite article of claim 6, wherein the sporting equipment is selected from the group consisting of a golf club shaft, a fishing rod, an arrow shaft, a hockey stick, a bat, a racquet, a ski pole, and a walking stick.

8. The composite article of claim 1, wherein the stack comprises a sheet and said image substantially covers an entire outer surface of said sheet.

9. The composite article of claim 8, wherein the sheet is non-planar.

10. The composite article of claim 1, wherein each of the plies exhibit unique mechanical properties.

11. A composite article, comprising:
a) a plurality of plies of composite material arranged atop one another in a stack and bonded together with a resin material;
b) an image layer integrally formed with the stack and visible on at least one outer surface of the stack, the image layer further comprising:
i) a saturating cellulose material saturable with the resin material prior to curing of the composite article to incorporate the image layer into the stack of plies by surrounding and infiltrating the saturating cellulose material of the image layer with the resin material; and
ii) an ink layer disposed substantially on an image side of the cellulose material, the ink layer forming an image.

12. A composite article in accordance with claim 11, wherein the ink layer forms an image applied to the saturating cellulose material by a conventional printing process prior to curing of the resin material in the stack of layers.

13. The composite article of claim 12, wherein the conventional printing process is selected from the group consisting of ink jet printing, laser printing, pen plotting, hand writing, and combinations thereof.

14. The composite article of claim 11, wherein said image is selected from the group consisting of a logo, alpha-numeric characters, a graphic, a photograph, a picture, and combinations thereof.

15. The composite article of claim 11, wherein said stack is shaped as an article of sporting equipment selected from the group consisting of a golf club shaft, a fishing rod, an arrow shaft, a hockey stick, a bat, a racquet, a ski pole, and a walking stick.

16. A method for fabricating an article of composite material, comprising:
stacking a plurality of plies made from composite materials on top of one another to form a composite stack;
wetting the composite stack by surrounding and infiltrating each of the plurality of plies with an uncured resin material;
printing an image on an image layer with a conventional printer;
placing the image layer on the stack of plies so that the printed image is visible on at least one outer surface of the stack of plies;
wetting the image layer with the uncured resin material to incorporate the image layer into the stack of plies by surrounding and infiltrating a saturating cellulose material of the image layer with the uncured resin material; and
curing the resin material to integrate the image layer into the composite article.

17. The method of claim 16, wherein the step of printing an image on an image layer further includes depositing an ink layer on an image bearing side of the saturating cellulose material, the image bearing side being substantially free of perforations to reduce transference of ink through the saturating cellulose material to a non-image bearing side.

18. The method of claim 16, wherein the step of wetting the image layer with the uncured resin further includes exposing the composite stack and image layer to a vacuum pressure to draw resin through the image layer to infiltrate and surround the cellulose material of the image layer.

19. The method of claim 16, wherein the conventional printer process is selected from the group consisting of an ink jet printer, a laser printer, a pen plotter, a hand writing instrument, and combinations thereof.

20. The process of claim 16, further comprising:
disposing a sealing material about the composite stack and the image layer prior to curing of the resin in the composite stack.
